(19) United States
(12) Patent Application Publication
(10) Pub. No.: US 2007/0174516 A1
(43) Pub. Date: Jul. 26, 2007

(54) ADAPTOR

(75) Inventor: Chih-Ling Wang, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/306,562

(22) Filed: Jan. 3, 2006

(51) Int. Cl. G06F 13/38

(52) U.S. Cl. 710/62

(57) ABSTRACT

An adaptor is provided. The adaptor comprises a microcontroller for converting command and data transmission between a host end and a memory card. Therefore, only one memory card circuit is required on a circuit board of the host end. Accordingly, it is possible to minimize space occupation on the circuit board of the host end. Thus, the production yield can be effectively increased and the production cost can be effectively reduced.

### BACKGROUND OF INVENTION

1. Field of the Invention

The present invention is generally relates to an adaptor, and more particularly to an adaptor which minimize space occupation of the circuit board of the host end, increase production yield and reduce production cost.

2. Description of Related Art

Rapid advancement of the computer technology has developed a variety of computerized products, for example, electronic dictionary, electronic translator, digital camera and other portable electronic devices. These portable electronic devices all are required to be connected to a computer for retrieving data there-from, editing or saving data therein. Taking the digital camera as the example, memory card is used to store the converted digital data instead of conventional film. However, the digital camera is required to convert data to transmit to a computer for storage, display or printing the digital images captured by the digital camera.

With the progressive advancement of technology, the application of memory card has been further developed compared to the traditional disk. Memory cards available on the market, for example, memory stick (MS) card, secure digital (SD) card, multi media card (MMC), compact flash (CF) card or smart media (SM) card advantageously have larger storage capacity and are also light, thin, short and small in size. However, due to many kinds of memory cards mentioned above, electronic devices are required to be equipped with a plurality of corresponding connections slots and memory card circuits on the circuit board for connecting and using the different kinds of memory cards. Thus, this would occupy more space on the circuit board, and thereby limit the electronic device from the present trend of being lighter, thinner, shorter and smaller. Besides, error could easily occur while welding a plurality of memory card circuits on the memory card connection interface, and accordingly adversely affect the production yield and increase the production cost.

Therefore, how to reduce the number of the memory card circuits on the circuit board of the electronic device, and still allow the user to use different kinds of memory cards in the electronic device, is an important issue for the manufacturers in the field.

### SUMMARY OF THE INVENTION

According to an aspect of the present invention, the adaptor comprises a microcontroller for converting command and data transmission between a host end and a memory card. Therefore, only one memory card circuit is required on a circuit board of the host end. Accordingly, it is possible to minimize space occupation on the circuit board of the host end. Thus, the production yield can be effectively increased and the production cost can be effectively reduced.

### BRIEF DESCRIPTION OF THE DRAWING

FIG. 1 is a block diagram of an adaptor according to an embodiment of the present invention.

FIG. 2 is a block diagram of an adaptor according to another embodiment of the present invention.

FIG. 3 is a block diagram of an adaptor according to another embodiment of the present invention.

FIG. 4 is perspective view of signal transmission of an adaptor according to another embodiment of the present invention.

FIG. 5 is a block diagram of an adaptor according to another embodiment of the present invention.

### DETAIL DESCRIPTION OF THE EMBODIMENTS

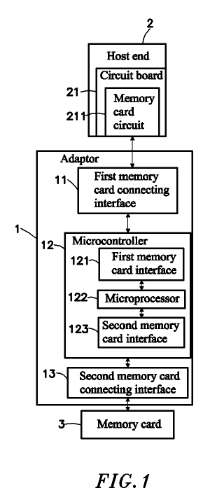

Referring to FIG. 1, an adaptor 1 of the present invention comprises a first memory card connecting interface 11 connected to a microcontroller 12 and a second memory card connecting interface 13.

The first memory card connecting interface 11 is electrically connected to a memory card circuit 211 on a circuit board 21 of a host end 2.

The microcontroller 12 comprises a first memory card interface 121 electrically connected to a microprocessor 122 and a second memory card interface 123. The first memory card interface 121 and the second memory card interface 123 are electrically connected to the first memory card connecting interface 11 and the second memory card connecting interface 13 respectively.

The second memory card connecting interface 13 is adopted for connecting to a memory card 3.

After the second memory card connecting interface 13 is electrically connected to the memory card 3, the host end 2 issues a storing command to the memory card 3. When the host end 2 commands to store data in a format of the first memory card interface 121, the command is transmitted from the memory card circuit 211 to the memory card interface 121 of the microcontroller 12 via the first memory card connecting interface 11, and the microprocessor 122 converts the command received by the first memory card interface 121 into a format of the second memory card interface 123 and then transmits to the second memory card interface 123. Finally, the storing command is completed by the second memory card interface 123. At this time, the data is transmitted from the host end 2 to the microprocessor 122 through the first memory card connecting interface 11 and the first memory card interface 121, and the microprocessor 122 converts the data into the format of the second memory card interface 123 and then transmits the data to the memory card 3 for storing via the second memory card interface 123 and the second memory connecting interface 13.

Furthermore, when the host end 2 needs to read data stored in the memory card 3, the host end 2 issues a read command in the format of the first memory card interface 121. The command is then transmitted from the memory card circuit 211 to the first memory card interface 121 of the microcontroller 12 via the first memory card connecting interface 11. The microprocessor 122 converts the command received by the first memory card interface 121 into the format of the second memory card interface 123 and then transmits to the second memory card interface 123. Finally, the command is completed by the second memory card interface 123. At this time, the memory card 3 transmits the data to the second memory card interface 123 via the second memory card connecting interface 13, the microprocessor 122 converts the data into the format of the first memory card interface 121 and then transmit to host end 2 via the first memory card interface 121 and the first memory card connecting interface 11.

The first memory card connecting interface 11 and the second memory card connecting interface 13 may be comprised of a memory stick (MS) card connecting interface, a secure digital (SD) card connecting interface, a multi media card (MMC) connecting interface, a compact flash (CF) card connecting interface or a smart media (SM) card connecting interface. The first memory card interface 121 and the second memory card interface 123 may be comprised of a memory stick (MS) card interface, a secure digital (SD) card interface, a multi media card (MMC) interface, a compact flash (CF) card interface or a smart media (SM) card interface.

The host end 2 may be a desktop computer, a notebook computer or a digital camera. The memory card 3 may be a memory stick (MS), a secure digital (SD), a multi media card (MMC), a compact flash (CF) or a smart media (SM).

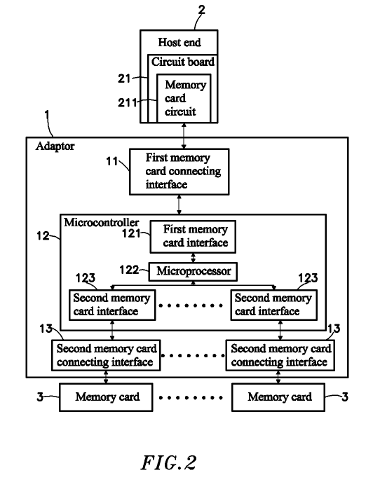

Referring to FIG. 2, the adaptor 1 of the present invention comprises a plurality of second memory card connecting interfaces 13, and the microprocessor 122 of the microcontroller 12 is electrically connected to a plurality of second memory card interfaces 123 with various specifications. Additionally, each of the second memory card interfaces 123 is electrically connected to the different memory card connecting interface 13. Thus, the host end 2 is capable of processing data reading or saving to the different memory cards 3 using only a single memory card circuit 211 on the circuit board 21 of the host end 2. Thus, the space occupation on the circuit board 21 of the host end 2 can be effectively minimized for allowing size reduction, the production yield can be effectively promoted and the production cost can also be effectively reduced.

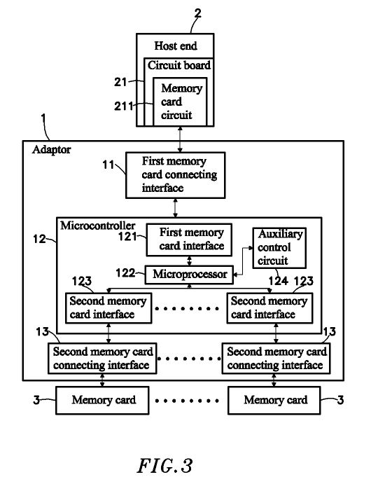

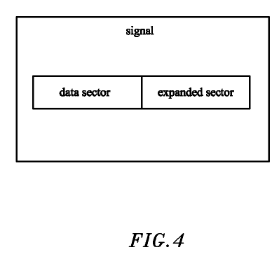

Referring to FIG. 3 and 4, the microprocessor 122 of the microcontroller 12 is electrically connected to an auxiliary control circuit 124 controlled by the microprocessor 122. The auxiliary control circuit 124 may be adopted for identifying a signal received by the microcontroller 12 as a data or a command. The command transmission signal is 1 byte, and the data transmission signal is 512 plus 16 bytes, wherein 512 bytes is a data sector, and 16 bytes is an expanded sector for saving information in the memory card 3, for example, ready, busy, CRC error, command error and so on. And every byte is comprised of 8 bits or 16 bits.

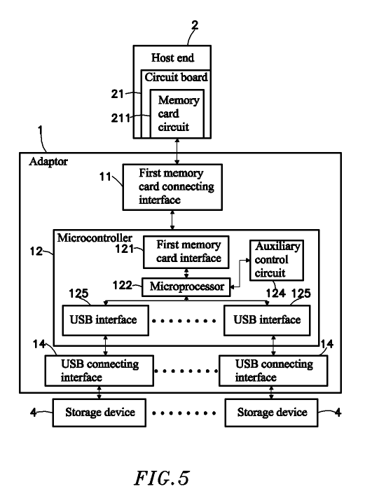

Referring to FIG. 5, the adaptor 1 of the present invention comprises the first memory card connecting interface 11 electrically connected to the microcontroller 12 and a USB connecting interface 14. The microcontroller 12 comprises the first memory card interface 121 electrically connected to the microprocessor 122 and a USB interface 125. The first memory card connecting interface 11 is electrically connected to the memory card circuit 211 on the circuit board 21 of the host end 2. After a storage device 4 is electrically connected to the USB connecting interface 14, the host end 2 may issue a read or storing command to the storage device 4 and use the microprocessor 122 of the microcontroller 12 to convert the command and data in the format of the first memory card interface 121 and the USB interface 125 to enable the host end 2 to process data saving/reading to the storage device 4. Thus, only a single memory card circuit 211 is required on the circuit board 21 of the host end 2. Thus, the space occupation on the circuit board 21 of the host end 2 can be effectively minimized for allowing size reduction, the production yield can be effectively promoted and the production cost can also be effectively reduced.

Furthermore, the storage device 4 may be comprised of a memory stick or a hard disk. The USB connecting interface 14 and the USB interface 125 may be one or plural.

Therefore, the adaptor 1 of the present invention is more advantageous than the conventional art, wherein the microcontroller 12 is adopted for converting the command and data transmitted between the host end 2 and the memory card 3. Thus, only a single memory card circuit 211 is needed on the circuit board 21 of the host end 2 for processing data reading or saving to different memory cards 3. Thus, the space occupation on the circuit board 21 of the host end 2 can be effectively minimized meeting the modern trend of being lighter, thinner, shorter and smaller. Furthermore, the production yield can be effectively promoted and the production cost can also be effectively reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. An adaptor, comprising: a microcontroller, comprising a first memory card interface, a second memory card interface and a microprocessor, wherein said first memory card interface and said second memory card interface are electrically connected to said microprocessor; p1 a first memory card connecting interface, electrically connected to said microcontroller and
a circuit board of a host end; and
a second memory card connecting interface, electrically connected to said microcontroller and a memory card, wherein said first memory card interface and said second memory card interface of said microcontroller are electrically connected to said first memory card connecting interface and said second memory card interface respectively, and when said host end processes data saving/reading to said memory card, said microprocessor converts a command or data transmitted from said host end into a format of said second memory card interface and then transmits to said memory card for storage and said data transmitted by said memory card is converted into a format of said first memory card interface by said microprocessor and then transmitted to said host end.

2. The adaptor as claimed in claim 1, wherein said second memory card interface and said second memory card connecting interface are one or plural.

3. The adaptor as claimed in claim 1, wherein said microprocessor is further electrically connected to an auxiliary control circuit for identifying received signals as data or commands.

4. The adaptor as claimed in claim 1, wherein said first memory card interface comprises a memory stick (MS) card interface, a secure digital (SD) card interface, a multi media card (MMC) interface, a compact flash (CF) card interface or a smart media (SM) card interface.

5. The adaptor as claimed in claim 1, wherein said second memory card interface comprises a memory stick (MS) card interface, a secure digital (SD) card interface, a multi media card (MMC) interface, a compact flash (CF) card interface or a smart media (SM) card interface.

6. The adaptor as claimed in claim 1, wherein said host end comprises a desktop computer, a notebook computer or a digital camera.

7. An adaptor, comprising:
a microcontroller, comprising a first memory card interface, a USB interface and a microprocessor, wherein said first memory card interface and said USB interface are electrically connected to said microprocessor;
a first memory card connecting interface, electrically connected to said microcontroller and
a circuit board of a host end; and
a USB connecting interface, electrically connected to said microcontroller and a storage device, wherein said first memory card interface and said USB interface are electrically connected to said first memory card connecting interface and said USB connecting interface respectively, and when said host end processes data saving/reading to said storage device, said microprocessor converts a command or data transmitted from said host end into a format of said USB interface and then transmits to said storage device for storage and said data transmitted by said storage device is converted into a format of said first memory card interface by said microprocessor and then transmitted to said host end.

8. The adaptor as claimed in claim 7, wherein said USB connecting interface and said second USB interface are one or plural.

9. The adaptor as claimed in claim 7, wherein said microprocessor is further electrically connected to an auxiliary control circuit for identifying received signals as data or commands.

10. The adaptor as claimed in claim 7, wherein said first memory card interface comprises a memory stick (MS) card interface, a secure digital (SD) card interface, a multi media card (MMC) interface, a compact flash (CF) card interface or a smart media (SM) card interface.

11. The adaptor as claimed in claim 7, wherein said host end comprises a desktop computer, a notebook computer or a digital camera.

12. The adaptor as claimed in claim 7, wherein said storage device comprises a memory stick or a hard disk.
